(19) United States
(12) Patent Application Publication
(10) Pub. No.: US 2007/0207374 A1
(43) Pub. Date: Sep. 6, 2007

(54) MEMBRANE-ELECTRODE ASSEMBLY FOR FUEL CELL AND FUEL CELL SYSTEM INCLUDING SAME

(75) Inventors: Chan-Gyun Shin, Yongin-si (KR); Sang-Il Han, Yongin-si (KR); In-Hyuk Son, Yongin-si (KR); Ho-Jin Kweon, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/682,000

(22) Filed: Mar. 5, 2007

(30) Foreign Application Priority Data
Mar. 3, 2006 (KR) 10-2006-0020416

(51) Int. Cl. H01M 4/86; H01M 8/10; B05D 5/12; H01M 4/88

(52) U.S. Cl. 429/44; 429/30; 427/115; 502/101

(57) ABSTRACT

A membrane-electrode assembly includes a polymer electrolyte membrane, and a cathode and an anode disposed on each side of a polymer electrolyte membrane. The anode includes a catalyst layer contacted with the polymer electrolyte membrane and an electrode substrate disposed the other surface of the catalyst layer. The electrode substrate includes a first surface contacted with the catalyst layer and a second surface not contacted with the catalyst layer, and the first surface is hydrophilic. Or, the electrode substrate includes a first electrode substrate contacted with the catalyst layer, and a second electrode substrate disposed to contact with the first electrode substrate wherein the first electrode substrate is hydrophilic.

### CROSS-REFERENCE TO RELATED APPLICATIONS

This application claims the benefit of Korean Patent Application No. 2006-20416 filed in the Korean Intellectual Property Office on Mar. 3, 2006, the disclosure of which is incorporated herein by reference.

### BACKGROUND OF THE INVENTION

1. Field of the Invention

Aspects of the present invention relate to a membrane-electrode assembly for a fuel cell and a fuel cell system including the same. More particularly, aspects of the present invention relate to a membrane-electrode assembly for a fuel cell capable of improving cell activity due to a smooth fuel supply, and a fuel cell system including the same.

2. Description of the Related Art

A fuel cell is a power generation system for producing electrical energy through an electrochemical redox reaction of an oxidant and a reductant, such as hydrogen in a hydrocarbon-based material. Such hydrocarbon-based materials include methanol, ethanol, and natural gas. Generally, a fuel cell includes a stack of unit cells and produces various ranges of power output. Since fuel cell stacks have an energy density four to ten times higher than a small lithium battery, the fuel cell has been highlighted as a small, portable power source.

Representative exemplary fuel cells include a polymer electrolyte membrane fuel cell (PEMFC) and a direct oxidation fuel cell (DOFC).

The polymer electrolyte fuel cell is a clean energy source that is capable of replacing fossil fuels. The PEMFC has advantages such as a high power output density and a high energy conversion efficiency. The PEMFC is operable at room temperature small, and tightly sealed. Therefore, the PEMFC is applicable to a wide array of fields such as non-polluting automobiles, electricity generation systems, and portable power sources for mobile equipment, military equipment, and the like.

Although the PEMFC has a high energy density, the PEMFC has problems in that hydrogen is supplied to the anode as a fuel gas. Hydrogen gas is explosive and the production of hydrogen requires accessory facilities, such as a fuel reforming processor for reforming methane or methanol, natural gas, and the like.

In contrast, the DOFC includes a direct methanol fuel cell (DMFC) that uses methanol directly as a fuel supplied to an anode. DOFCs have a lower energy density than PEMFCs, but DOFCs do not require accessory facilities for additional fuel reforming processes. Furthermore fuels supplied to the anodes of DOFCs are safer than hydrogen, and DOFCs are operable at room temperature having a low operation temperature.

In the above fuel cells, a stack that generates electricity generally includes several to scores of unit cells stacked in multiple layers. And, each unit cell is formed of a membrane-electrode assembly (MEA) and a separator (also referred to as a bipolar plate). The membrane-electrode assembly is disposed between an anode (also referred to as a fuel electrode or an oxidation electrode) and a cathode (also referred to as an air electrode or a reduction electrode).

A fuel is supplied to the anode and adsorbed on catalysts of the anode where the fuel is oxidized to produce protons and electrons. The electrons are transferred to the cathode via an external circuit, and the protons are transferred to the cathode through the polymer electrolyte membrane. The electrons flowing from the anode to the cathode through the external circuit generate useful current. In addition, an oxidant is supplied to the cathode, and then the oxidant, protons, and electrons are reacted on catalysts of the cathode to produce water.

### SUMMARY OF THE INVENTION

Aspects of the present invention provide a membrane-electrode assembly for a fuel cell capable of facilitating a smooth fuel supply.

Another aspect of the present invention provides a fuel cell system including the membrane-electrode assembly.

According to aspects of the present invention, a membrane-electrode assembly for a fuel cell includes: a polymer electrolyte membrane; and a cathode and an anode respectively disposed on each surface of the polymer electrolyte membrane. The anode includes a catalyst layer having a first surface disposed to contact the polymer electrolyte membrane and an electrode substrate disposed on a second surface of the catalyst layer. The electrode substrate includes a first surface disposed to contact the catalyst layer and a second surface disposed not to contact the catalyst layer. The first surface is hydrophilic.

The hydrophilicity is increased from the second surface to the first surface.

The contact angle of the first surface of the electrode substrate is at or between 0 and 40°, and the contact angle of the second surface is at or between 40 and 80°. According to one aspect, the contact angle of the first surface of the electrode substrate is at or between 0 and 15°, and the contact angle of the second surface is at or between 40 and 60°.

The first surface of the electrode substrate may include at least one selected from the group consisting of O₂, argon, N₂, and a mixture thereof.

According to another aspect of the present invention, an anode includes a catalyst layer having a first surface disposed to contact the polymer electrolyte membrane and an electrode substrate disposed on a second surface of the catalyst layer, the electrode substrate including a first surface of a first electrode substrate disposed to contact the second surface of the catalyst layer and a second electrode substrate having a first surface disposed to contact a second surface of the first electrode substrate, wherein the first electrode substrate is hydrophilic.

The contact angle of the first surface of the first electrode substrate disposed to contact the second surface of the catalyst layer is at or between 0 and 40°, and the contact angle of the second surface of the second electrode substrate disposed not to contact the first electrode substrate is at or between 40 and 80°. According to one aspect, the contact angle of the first surface of the first electrode substrate disposed to contact the second surface of the catalyst layer is at or between 0 and 15°, and the contact angle of the second surface of the second electrode substrate disposed not to contact the first electrode substrate is at or between 40 and 60°.

The surface where the first surface of the electrode substrate disposed to contact the second surface of the catalyst layer may include at least one selected from the group consisting of O₂, argon, N₂ and a mixture thereof.

According to another aspect of the present invention, a fuel cell stem is provided. The fuel cell system includes: at least one electricity generating element adopted to generate electricity through oxidation of fuel and reduction of an oxidant; a fuel supplier adopted to supply the fuel to the electricity generating element; and an oxidant supplier adopted to supply the oxidant to the electricity generating element. The electricity generating element includes: an electrode-membrane assembly including an anode and a cathode facing each other; a polymer electrolyte membrane disposed between the anode and the cathode; and a separator. The anode includes the electrode substrate having the above structure.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic cross-sectional view showing a membrane-electrode assembly according to aspects of the present invention.

FIG. 2 is a schematic cross-sectional view showing a membrane-electrode assembly according to aspects of the present invention.

FIG. 3A to 3D are views showing contact angles with respect to a substrate.

FIG. 4 schematically shows the structure of a fuel cell system according aspects of the present invention.

FIG. 5 shows voltages and current density of single cells according Example 1 and Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

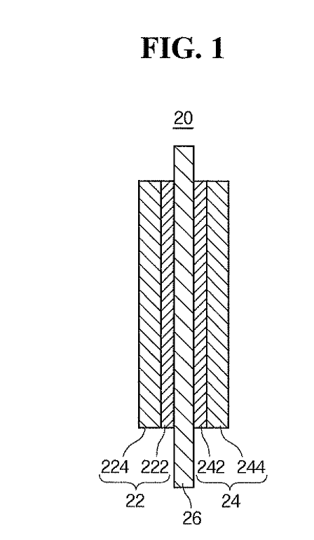

Referring to FIG. 1, a membrane-electrode assembly 20 of a fuel cell includes an anode 22, a cathode 24, and a polymer electrolyte membrane 26 disposed between the anode 22 and the cathode 24. Each of the anode 22 and the cathode 24 includes an electrode substrate, respectively 224 and 244, and a catalyst layer, respectively 222 and 242. A fuel is supplied to the anode 22, and an oxidant is supplied to the cathode 24 in the fuel cell. Thereby, electrical energy is generated by oxidation of the fuel and reduction of the oxidant.

According to aspects of the present invention, the properties of the electrode substrate 224 of the anode 22 are adjusted to provide a smooth fuel supply in order to improve the performance of the fuel cell.

FIG. 1 is a schematic cross-sectional view showing a membrane-electrode assembly 20 according to aspects of the present invention. The membrane-electrode assembly 20 includes the anode 22 and a cathode 24 with a polymer electrolyte membrane 26 disposed between the anode 22 and the cathode 24. The anode 22 comprises the catalyst layer 222 and the electrode substrate 224. The cathode comprises the catalyst layer 242 and the electrode substrate 244. The anode 22 includes the catalyst layer 222 having a first surface to contact the polymer electrolyte membrane 26 and a second surface, opposite the first surface, on which the electrode substrate 224 is formed. The electrode substrate 224 includes a first surface to contact the second surface of the catalyst layer 222 and a second surface that does not contact the catalyst layer 222. The first surface of the electrode substrate 224 is hydrophilic. According to aspects of the current invention, the hydrophilicity increases from the second surface of the electrode substrate 224 to the first surface electrode substrate 224. In the other words, the hydrophilicity of the first surface of the electrode substrate 224 is higher than that of the second surface of the electrode substrate 224.

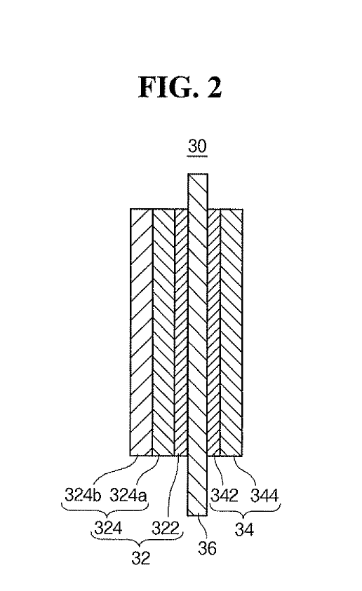

FIG. 2 is a schematic cross-sectional view showing a membrane-electrode assembly 30 according to aspects of the present invention. The membrane-electrode assembly 30 comprises an anode 32, a cathode 347 and a polymer electrolyte membrane 36 disposed between the anode 32 and the cathode 34. The cathode 34 includes a catalyst layer 342 and an electrode substrate 344. The anode 32 includes a catalyst layer 322 and a double-layered electrode substrate 324. The double-layered electrode substrate 324 of the anode 32 includes a hydrophilic electrode substrate 324a and a relatively less hydrophilic electrode substrate 324b. Although the membrane-electrode assembly 30 described herein includes the double-layered electrode substrate 324 in contact with the catalyst layer 322, the electrode substrate 324 is not limited thereto and may be fabricated with a multi-layered electrode substrate so that the electrode substrate 324 comprises a plurality of electrode substrate layers of varying hydrophilicity. The multi-layered electrode substrate 324 may include a plurality of electrode substrate layers, of which the hydrophilicity increases closer to the second surface of the catalyst layer. The multi-layers electrode substrate 324 may be arranged in order of hydrophilicity having the most hydrophilic electrode substrate layer disposed to contact the second surface of the catalyst layer 322.

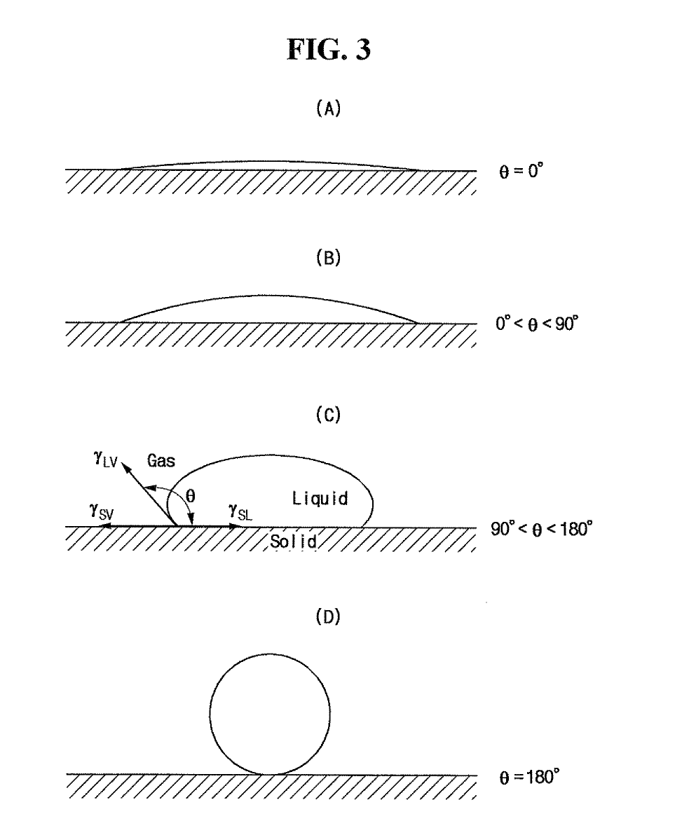

To determine whether the substrate is hydrophilic, the contact angle θ with respect to the surface is measured. Generally, the hydrophilicity of the substrate is quantitatively determined by measuring the contact angle θ with respect to the surface, the detailed description relating to this is omitted. Hereinafter, it is simply described referring to FIGS. 3A to 3D.

As shown in FIGS. 3A to 3D, the contact angle θ is determined between the contact surface of liquid-solid-gas and the contact point of the end point of the water drop curve contacted with the solid surface, or the contact angle θ is the measure of the angle between the surface of a material, the hydrophilicity of which is to be determined, and the surface of the water droplet on the surface of the material. Accordingly, the contact angle is 0 in FIG. 3A. The contact angle θ is 0<θ<90° in FIG. 3B. The contact angle is 90°<θ<180° in FIG. 3C. And, the contact angle is 180° in FIG. 3D. If the contact angle θ is 90° or more, the surface is a hydrophobic surface; and, if the contact angle is less than 90°, the surface is a hydrophilic surface.

According to aspects of the present invention, the first surfaces of the electrode substrates 224 and 324 of the anodes (22 of FIG. 1, and 324 of FIG. 2) that contact the second surfaces of the catalyst layers 222 and 322, respectively, have contact angles θ between about 0° and 40°, inclusive. And, contact angles θ of the second surfaces of the electrode substrates 224 and 324, which do not contact the catalyst layers 222 and 322 and are opposite to the first surfaces of the electrode substrates 224 and 324, are between about 40° and 80°. According to aspects of the present invention, the first surfaces of the electrode substrates 224 and 324 that contact the catalyst layers 222 and 322 of the anodes 22 and 32, respectively, have contact angles θ of between about 0 and 15°, inclusive. And, contact angles θ of the second surfaces of the electrode substrates 224 and 324, which do not contact the catalyst layers 222 and 322 and are opposite to the first surfaces of the electrode substrates 224 and 324, are between about 40° and 60°, inclusive. Accordingly, the first surfaces of the electrode substrates 224 and 324 have higher hydrophilicity than the second surfaces of the electrode substrates 224 and 324. A smooth fuel supply from the first surface to the second surface of the electrode substrates 224 and 324 to the anodes 22 and 32 results when the hydrophilicity of the first surface is about two times higher than that of the second surface.

Furthermore, the first surfaces of the electrode substrates 224 and 324 of the anodes 22 and 32, respectively, may include at least one of O₂, argon, N₂, or a mixture thereof.

With regard to FIG. 1, the electrode substrate 224 supports the anode 22, and the electrode substrate 244 supports the cathode 24. The electrode substrates 224 and 244 respectively provide paths for transferring reactants, such as the fuel and the oxidant, to the catalyst layers of the 222 and 242. With regard to FIG. 2, the electrode substrate 324 supports the anode 32, and the electrode substrate 344 supports the cathode 34. And, the electrode substrates 324 and 344 respectively provide paths for transferring reactants, such as the fuel and the oxidant, to the catalyst layers 322 and 342. The electrode substrates (224, 244, 324, and 344) may be formed from a material such as a carbon paper, a carbon cloth, a carbon felt, or a metal cloth (a porous film may include a metal fiber or a metal film disposed on a surface of a cloth of polymer fibers). However, the electrode substrates 224, 244, 324, and 344 are not limited thereto.

The electrode substrates 224 and 324 of the anodes 22 and 32 include first surfaces in contact with the second surfaces of the catalyst layers 222 and 322, respectively. The electrode substrates 224 and 324 of the anodes 22 and 32 also respectively include second surfaces that do not contact the catalyst layers 222 and 322. In addition, the first surfaces of the electrode substrates 224 and 324 have higher hydrophilicity than that of the second surfaces of the electrode substrates 224 and 324. By respectively employing the electrode substrates 224 and 324 of the anodes 22 and 32 to the membrane-electrode assemblies 20 and 30 for a fuel cell, the fuel is smoothly transferred into the catalyst layers 222 and 322 by osmosis. Further, as the second surfaces thereof have lower hydrophilicity, the second surfaces of the electrode substrates 224 and 324 of the anodes 22 and 32 have lower surface energy. Thus, the fuel is more easily permeated into the electrode substrates 224 and 324 of the anodes 22 and 32. As the fuel is more smoothly supplied into the catalyst layers 222 and 322 of the anodes 22 and 32, the electrode substrates 224 and 324 of the anodes 22 and 32 promote the electrochemical reaction in the fuel cell to improve the performance thereof.

A material having a similar surface energy to the electrode substrates 224 and 324 of the anodes 22 and 32 can be obtained in accordance with Choi, Sung-Hwan, and Zhang Newby, Bi-min., “Alternative Method for Determining Surface Energy by Utilizing Polymer Thin Film Dewetting”, Langmuir, Vol. 19, Issue 4, pp. 1419-1428, (2003).

The electrode substrate can be effectively adapted to the passive type (or air breathing type) fuel cell system where the fuel is supplied without a pump.

With regard to producing an electrode substrate according to aspects of the current invention, the electrode substrate for the anode is fabricated by being subjected to a hydrophilic treatment, such as plasma treatment. The plasma treatment includes the operation of exposing the surface of the electrode substrate to a partially ionized gas in a plasma state to reform the surface thereof resulting in a plasma-treated electrode substrate. Since the treatment is effected on a small area, the electrode itself is not damaged and the other substrate materials are not deformed. Also, contamination is prevented. Further, the plasma treatment improves the electro-conductivity of the electrode substrate.

Hereinafter, the plasma treatment will be described in more detail.

The electrode substrate generally used as an anode of a fuel cell is introduced into a plasma chamber with one surface exposed and the other surface opposite the exposed surface masked with a protective layer. Then, the exposed surface of the electrode substrate is subjected to the plasma treatment under one of various gas atmospheres at vacuum pressures, such as Ar, N₂, and O₂ or a mixture thereof, and an electrical power ranging from 100 to 300 W.

An anode comprises the above electrode substrate according to aspects the present invention and a catalyst layer. The catalyst layer includes at least one catalyst layer selected from the group consisting of platinum, ruthenium, osmium, a platinum-ruthenium alloy, a platinum-osmium alloy, a platinum-palladium alloy, a platinum-M alloy, or combinations thereof, where M is a transition element selected from the group consisting of Ga, Ti, V, Cr, Mn, Fe, Co, Ni, Cu, Zn, Sn, Mo, W, Rh, and combinations thereof. Representative examples of the catalyst include at least one selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and combinations thereof.

Such a metal catalyst may be used in a form of a metal itself (black catalyst) or can be used while being supported on a carrier. The carrier may include carbon-containing molecules such as acetylene black, denka black, activated carbon, ketjen black, or graphite, or an inorganic particulate such as alumina, silica, zirconia, or titania.

The cathode may include the same metal catalyst as the anode.

The catalyst layer may further include a binder resin to improve its adherence and proton transfer properties.

The binder resin may be a proton conductive polymer resin having a cation exchange group selected from the group consisting of a sulfonic acid group, a carboxylic acid group, a phosphoric acid group, a phosphonic acid group, and derivatives thereof, as a side chain. Non-limiting examples of the polymer include at least one proton conductive polymer selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. According to aspects of the present invention, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly (2,5-benzimidazole).

The binder resin may be used singularly or as a mixture. Or, the binder resin may be used along with a non-conductive polymer to improve adherence of the polymer electrolyte membrane and the catalyst layer. The amount of the binder resin may be adjusted according to usage requirements.

Non-limiting examples of the non-conductive polymer include polytetrafluoroethylene (PTFE), tetrafluoroethylene-hexafluoropropylene copolymers (FEP), tetrafluoroethylene-perfluoro alkyl vinylether copolymers (PFA), ethyleneltetrafluoroethylene (ETFE)), ethylenechlorotrifluoro-ethylene copolymers (ECTFE), polyvinylidene fluoride, polyvinylidene fluoride-hexafluoropropylene copolymers (PVdF-HFP), dodecylbenzene sulfonic acid, sorbitol, and combinations thereof.

In a membrane-electrode assembly according to aspects of the present invention, the polymer electrolyte membrane includes any proton conductive polymer resin. The proton conductive polymer resin may be a polymer resin having a cation exchange group selected from the group consisting of a sulfonic acid group, a carboxylic acid group, a phosphoric acid group, a phosphonic acid group, and derivatives thereof, at its side chain. Further, the cation exchange resin has an ion-exchange ratio ranging from 3 to 33, and an equivalent weight (EW) ranging from 700 to 2,000. The “ion exchange ratio of the ion exchange resin” is defined to be determined by the number of carbons in the polymer backbone and the number of cation exchange groups The ion-exchange ratio ranging from 3 to 33 corresponds to an equivalent weight ranging from 700 to 2000.

Non-limiting examples of the polymer resin include at least one of the proton conductive polymers selected from the group consisting of fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. According to aspects of the present invention, the proton conductive polymer is at least one of the proton conductive polymers selected from the group consisting of poly(perfluorosulfonic acid), poly(perfluorocarboxylic acid), defluorinated polyetherketone sulfide, aryl ketone, poly(2,2′-(m-phenylene)-5,5′-bibenzimidazole), poly(2,5-benzimidazole), and a copolymer of tetrafluoroethylene and fluorovinylether having a sulfonic acid group.

According to aspects of the present invention, a fuel cell system including the above membrane-electrode assembly is provided. A fuel cell system according to aspects of the present invention includes at least one electricity generating element, a fuel supplier, and an oxidant supplier.

The electricity generating element includes a membrane-electrode assembly that includes a polymer electrolyte membrane disposed between a cathode, and an anode; and the membrane-electrode assembly is disposed between separators (or bipolar plates). The electricity generating element generates electricity through the oxidation of a fuel and the reduction of an oxidant.

The fuel supplier supplies a fuel, including hydrogen, to the electricity generating element. The fuel includes liquid or gaseous hydrogen, or a hydrocarbon-based fuel such as methanol, ethanol, propanol, butanol, or natural gas. And the oxidant supplier supplies an oxidant to the electricity generating element. The oxidant includes oxygen or air.

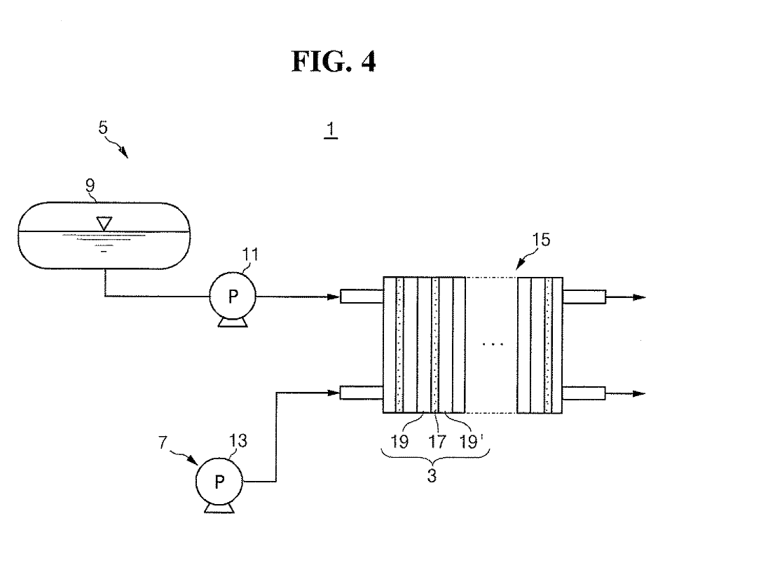

FIG. 4 shows a schematic structure of a fuel cell system 1 that will be described in detail with reference to this accompanying drawing, as follows. FIG. 4 illustrates a fuel cell system wherein a fuel and an oxidant are provided to the electricity generating element 3 through pumps 11 and 13, but the present invention is not limited to such a structure. The fuel cell system of the present invention alternatively includes a structure wherein a fuel and an oxidant are provided in a diffusion manner.

The fuel cell system 1 includes at least one electricity generating element 3 that generates electrical energy through an electrochemical reaction of a fuel and an oxidant, a fuel supplier 5 to supply a fuel to the electricity generating element 3, and an oxidant supplier 7 to supply an oxidant to the electricity generating element 3.

In addition, the fuel supplier 5 is equipped with a tank 9 that stores the fuel, and a pump 11 that is connected therewith. The pump 11 delivers the fuel stored in the tank 9 to the electricity generating element 3.

The oxidant supplier 7, which supplies the oxidant to the electricity generating element 3, is equipped with at least one pump 13 to deliver the oxidant to the electricity generating element 3.

The electricity generating element 3 includes a membrane-electrode assembly 17 which oxidizes hydrogen or a fuel and reduces an oxidant as described above according to aspects of the current invention. The membrane-electrode assembly 17 is disposed between separators 19 and 19′ that are respectively positioned at opposite sides of the membrane-electrode assembly. The separators 19 and 19′ supply hydrogen or a fuel and an oxidant to the anode and cathode, respectively, of the membrane-electrode assembly. A stack 15 comprises at least one electricity generating element 3.

The following example illustrates the present invention in more detail. However, it is understood that the present invention is not limited by this example.

### EXAMPLE 1

A carbon paper was introduced into a plasma chamber, and one surface thereof was masked. Then the exposed surface of the masked carbon paper was treated with plasma under vacuum pressures and an O₂ atmosphere flowing at 30 sccm, and 200 W resulting in an electrode substrate for an anode. The contact angle of the first surface of the electrode substrate, which was exposed and treated with the plasma, was 15°, and that of the second surface thereof, which was masked and not treated with the plasma, was 42°.

Pt black (HiSPEC® 1000, produced by Johnson Matthey PLC) and Pt/Ru black (HiSPEC®6000, produced by Johnson Matthey PLC) were mixed at a weight ratio of 5:5. 90 parts by weight of the mixed catalyst was added to a solvent mixture prepared by mixing water and isopropyl alcohol at a weight ratio of 10:80. 40 parts by weight of a NAFION® solution (NAFION® 1100EW produced by E. I. DuPont de Nemours and Company) was added to the solvent mixture and uniformly agitated by applying ultrasonic waves to thereby prepare a cathode catalyst layer-forming composition. A cathode was prepared by coating an untreated carbon paper electrode substrate with the cathode catalyst layer-forming composition.

An anode catalyst layer-forming composition for an anode was prepared by using only PtRu black catalyst (HiSPEC 6000, produced by Johnson Matthey PLC) and performing the above-described preparation method. 90 parts by weight of the catalyst was added to a solvent mixture prepared by mixing water and isopropyl alcohol at a weight ratio of 10:80. 40 parts by weight of a NAFION® solution (NAFION® 1100EW produced by E. I. DuPont de Nemours and Company) was added to the solvent mixture and uniformly agitated by applying ultrasonic waves to thereby prepare an anode catalyst layer-forming composition. An anode was prepared by coating the plasma-treated electrode substrate according to aspects of the present invention with the anode catalyst layer-forming composition.

A membrane-electrode assembly was fabricated by disposing the anode and the cathode on both sides of a commercial polymer electrolyte membrane for a fuel cell (NAFION® 115 Membrane, produced by E. I. DuPont de Nemours and Company). Herein, a 6 mg/cm² catalyst layer was formed in the anode, and a 4 mg/cm² catalyst layer was formed in the cathode.

The fabricated membrane-electrode assembly was disposed between gaskets, disposed again between two separators, each having a gas flow channel and a cooling channel of a predetermined shape. And, the membrane-electrode assembly and separators were then compressed between copper end plates to fabricate a single fuel cell.

### COMPARATIVE EXAMPLE 1

A single cell was fabricated by the same method as Example 1, except that a commercial carbon paper was used for both the anode and the cathode electrode substrates.

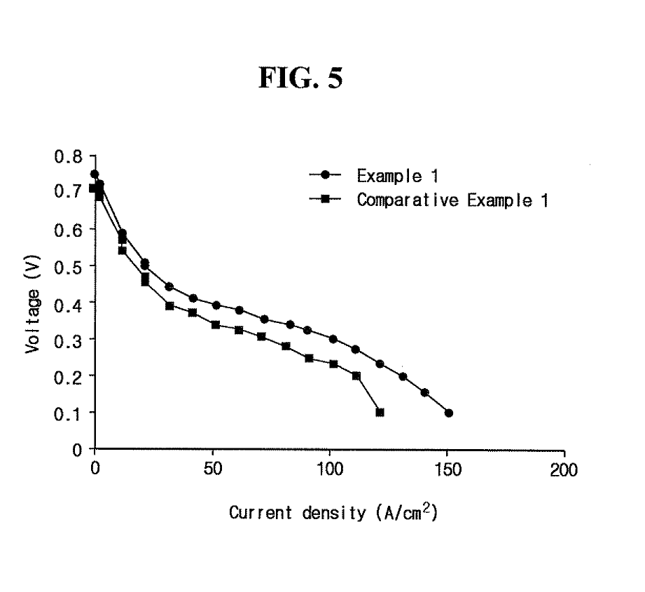

Single cells of Example 1 and Comparative Example 1 were measured regarding voltage while operating at 65° C. by supplying 1M methanol to the anode and dry air to the cathode, and the resultant measurements are shown in FIG. 5. As shown in FIG. 5, the cell according to Example 1 showed an improved driving voltage over the driving voltage of Comparative Example 1.

The membrane-electrode assembly accomplished a smooth fuel supply by controlling the properties of the electrode substrate and provided a fuel cell system having excellent performance.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A membrane-electrode assembly for a fuel cell comprising:
a polymer electrolyte membrane; and
a cathode and an anode disposed at respective sides of the polymer electrolyte membrane,
wherein the anode comprises a catalyst layer having a first surface disposed to contact the polymer electrolyte membrane and an electrode substrate disposed on a second surface of the catalyst layer,
wherein the electrode substrate comprises a first surface disposed to contact the second surface of the catalyst layer and a second surface disposed not to contact the catalyst layer, and
the first surface is hydrophilic.

2. The membrane-electrode assembly for a fuel cell of claim 1, wherein the hydrophilicity increases from the second surface of the electrode substrate to the first surface of the electrode substrate.

3. The membrane-electrode assembly for a fuel cell of claim 1, wherein the contact angle of the first surface of the electrode substrate is at or between about 0 and 40°, and the contact angle of the second surface of the electrode substrate is at or between about 40 and 80°.

4. The membrane-electrode assembly for a fuel cell of claim 3, wherein the contact angle of the first surface of the electrode substrate is at or between about 0 and 15°, and the contact angle of the second surface of the electrode substrate is at or between about 40 and 60°.

5. The membrane-electrode assembly for a fuel cell of claim 1, wherein the first surface of the electrode substrate includes at least one element selected from the group consisting of O₂, argon, N₂, and a mixture thereof.

6. The membrane-electrode assembly for a fuel cell of claim 1, wherein the electrode substrate is a plasma-treated electrode substrate provided by being subjected to a plasma treatment in which the first surface of the electrode substrate is exposed to a plasma and the second surface of the electrode substrate is masked.

7. A membrane-electrode assembly for a fuel cell comprising:
a polymer electrolyte membrane; and
a cathode and an anode disposed at respective sides of the polymer electrolyte membrane,
wherein the anode comprises a catalyst layer having a first surface disposed to contact the polymer electrolyte membrane and an electrode substrate disposed on a second surface of the catalyst layer,
wherein the electrode substrate comprises a first electrode substrate having a first surface disposed to contact the second surface of the catalyst layer and a second electrode substrate having a first surface disposed to contact the second surface of the first electrode substrate, and
the first electrode substrate is hydrophilic.

8. The membrane-electrode assembly for a fuel cell of claim 7, wherein the contact angle of the first surface of the first electrode substrate is between about 0 and 40°, and the contact angle of the second surface of the second electrode substrate is at or between about 40 and 80°.

9. The membrane-electrode assembly for a fuel cell of claim 8, wherein the contact angle of the first surface of the first electrode substrate is at or between about 0 and 15° and the contact angle of the second surface of the second electrode substrate is at or between about 40 and 60°.

10. The membrane-electrode assembly for a fuel cell of claim 7, wherein the first surface of the first electrode substrate includes at least one element selected from the group consisting of O₂, argon, N₂ and a mixture thereof.

11. The membrane-electrode assembly for a fuel cell of claim 7, wherein the first electrode substrate is a plasma-treated electrode substrate provided by subjecting the first electrode substrate to a plasma treatment in which the first surface of the first electrode substrate is exposed to a plasma.

12. A method of fabricating a membrane-electrode assembly comprising:
introducing an electrode substrate into a plasma chamber;
subjecting a first surface of the electrode substrate to a plasma,
disposing the first surface of the electrode substrate to contact a catalyst layer.

13. A fuel cell system comprising:
at least one electricity generating element to generate electricity through oxidation of a fuel and reduction of an oxidant and comprising
an electrode-membrane assembly comprising
an anode and a cathode facing each other, and
a polymer electrolyte membrane disposed between the anode and the cathode, and
a separator;
a fuel supplier to supply the fuel to the electricity generating element; and
an oxidant supplier to supply the oxidant to the electricity generating element,
wherein the anode comprises a catalyst layer having a first surface disposed to contact the polymer electrolyte membrane and an electrode substrate having a first surface disposed to contact a second surface of the catalyst layer, wherein
the electrode substrate comprises a first surface disposed to contact the second surface of the catalyst layer and a second surface disposed not to contact the catalyst layer, and
the first surface of the electrode substrate is hydrophilic.

14. The fuel cell system of claim 13, wherein the hydrophilicity increases from the second surface of the electrode substrate to the first surface of the electrode substrate.

15. The fuel cell system of claim 13, wherein the contact angle of the first surface of the electrode substrate is at or between about 0 and 40°, and the contact angle of the second surface of the electrodes substrate is at or between about 40 and 80°.

16. The fuel cell system of claim 151 wherein the contact angle of the first surface of the electrode substrate is at or between about 0 and 15°, and the contact angle of the second surface of the electrodes substrate is at or between about 40 and 60°.

17. The fuel cell system of claim 13, wherein the first surface of the electrode substrate includes at least one element selected from the group consisting of O₂, argon, N₂, and a mixture thereof.

18. A fuel cell system comprising:
at least one electricity generating element adopted to generate electricity through oxidation of a fuel and reduction of an oxidant and comprising:
an electrode-membrane assembly comprising:
an anode and a cathode facing each other, and
a polymer electrolyte membrane disposed between the anode and the cathode, and
a separator;
a fuel supplier adopted to supply the fuel to the electricity generating element; and
an oxidant supplier adopted to supply the oxidant to the electricity generating element,
wherein the anode comprises a catalyst layer having a first surface disposed to contact the polymer electrolyte membrane and an electrode substrate disposed on a second surface of the catalyst layer,
wherein the electrode substrate comprises a first electrode substrate having a first surface disposed to contact the second surface of the catalyst layer and a second electrode having a first surface disposed to contact with the second surface of the first electrode substrate, and
the first electrode substrate is hydrophilic.

19. The fuel cell system of claim 18, wherein the contact angle of the first surface of the first electrode substrate is at or between about 0 and 40°, and the contact angle of the second surface of the second electrode is at or between about 40 and 80°.

20. The fuel cell system of claim 19, wherein the contact angle of the first surface of the first electrode substrate is at or between about 0 and 15°, and the contact angle of the second surface of the second electrode substrate is at or between about 40 and 60°.

21. The fuel cell system of claim 18, wherein the first surface of the first electrode substrate includes at least one element selected from the group consisting of O₂, argon, N₂ and a mixture thereof.

22. The method of claim 12, further comprising:
masking a second surface of the electrode substrate to protect the second surface from being exposed to the plasma.

23. The method of claim 12, further comprising:
creating gas atmosphere of Ar, N₂, O₂, or a mixture thereof in the plasma chamber.

24. The method of claim 12, further comprising:
providing electrical power to the electrode substrate.

25. The method of claim 24, wherein the electrical power is provided at about 100 to 300 W.

26. The method of claim 12, further comprising:
subjecting first surfaces of a plurality of electrode substrates to a plasma.

27. The method of claim 26, further comprising:
disposing the first surface of an electrode substrate of the plurality of electrode substrates having a highest hydrophilicity to contact the catalyst layer, and
arranging the plurality of electrode substrates from a lowest hydrophilicity to the highest hydrophilicity in a direction toward the catalyst layer.

28. The method of claim 12, wherein the electrode substrate further comprises:
a plurality of electrode substrate layers,
wherein a first surface of a first electrode substrate layer of the plurality of electrode substrate layers is the first surface of the electrode substrate.

29. A method of fabricating a membrane-electrode assembly, the method comprising:
forming an anode to have a catalyst layer disposed on an electrode substrate, wherein the electrode substrate comprises:
a first surface and a second surface, and the first surface of the electrode substrate has a higher hydrophilicity than the second surface of the electrode substrate;
forming a cathode; and
disposing an electrolyte between the anode and the cathode so that the catalyst layer contacts the electrolyte.

30. The method of claim 29, wherein the method further comprises:
disposing the catalyst layer on the first surface of the electrode substrate.

31. The method of claim 29, wherein the electrode substrate further comprises:
a plurality of electrode substrate layers of differing hydrophilicities,
wherein a first surface of a first electrode substrate layer of the plurality of electrode substrate layers having a highest hydrophilicity is the first surface of the electrode substrate, and
the method further comprising:
arranging the plurality of electrode substrate layers in order of a lowest hydrophilicity to the highest hydrophilicity in a direction toward the catalyst layer; and
disposing the catalyst layer on the first surface of the electrode substrate.

32. A method of fabricating an anode for a fuel cell, comprising:
forming an anode catalyst composition;
forming an electrode substrate having a first surface and a second surface, wherein the first surface is more hydrophilic than the second surface; and
disposing the anode catalyst composition on the first surface of the electrode substrate.

33. The method of claim 32, wherein the electrode substrate further comprises:
a plurality of electrode substrate layers of differing hydrophilicities,
wherein a first surface of a first electrode substrate layer of the plurality of electrode substrate layers having a highest hydrophilicity is the first surface of the electrode substrate, and
the method further comprising:
arranging the plurality of electrode substrate layers in order of a lowest hydrophilicity to the highest hydrophilicity in a direction toward the catalyst layer.

34. An anode for a fuel cell, comprising:
a catalyst layer having a catalyst surface;
an electrode substrate having a first surface and a second surface;
wherein the first surface of the electrode substrate is more hydrophilic than the second surface of the electrode substrate.

35. The anode of claim 34, wherein the first surface of the electrode substrate contacts the catalyst surface.

36. The anode of claim 34, wherein the electrode substrate comprises:
a plurality of electrode substrate layers,
wherein each of the electrode substrate layers has a different hydrophilicity.

37. The anode of claim 36, wherein an electrode substrate layer with a highest hydrophilicity contacts the catalyst surface.

38. The anode of claim 37, wherein the plurality of electrode substrate layers are arranged from the lowest hydrophilicity to the highest hydrophilicity in a direction toward the catalyst layer.

39. A membrane-electrode assembly, comprising:
the anode of claim 34.

40. A fuel cell system, comprising:
a plurality of unit fuel cells each including the membrane-electrode assembly of claim 39.
